(19) United States
(12) Patent Application Publication
(10) Pub. No.: US 2014/0214543 A1
(43) Pub. Date: Jul. 31, 2014

(54) SYSTEM AND METHOD OF DISPLAYING TARGETED/PERSONALIZED ADS OR MESSAGES

(71) Applicant: Saumil Ashvin Gandhi, Sunnyvale, CA (US)

(72) Inventor: Saumil Ashvin Gandhi, Sunnyvale, CA (US)

(73) Assignee: eBay Inc., San Jose, CA (US)

(21) Appl. No.: 13/755,595

(22) Filed: Jan. 31, 2013

(51) Int. Cl. G06Q 30/02

(52) U.S. Cl. CPC G06Q 30/0267
USPC 705/14.58

(57) ABSTRACT

A method of controlling an electronic sign is provided. Identification information is received from a plurality of mobile devices approaching an electronic sign. Using the identification information, user profiles corresponding to the plurality of mobile devices are retrieved. Information from the user profiles is then aggregated. An advertisement or message to display to the plurality of mobile devices is then identified based on the aggregated information. The advertisement or message is then caused to be displayed on the electronic sign.

### TECHNICAL FIELD

This application relates generally to targeted advertising and, more specifically, to systems and methods for displaying targeted/personalized ads or messages.

### BACKGROUND

Billboard and other sign-based advertising techniques have existed for many years. Typically a billboard or sign-based advertisement is a general advertising message intended to pertain to a large number of people viewing the advertisement. In recent years, electronic billboards and signs have been gaining in popularity. These electronic billboards and signs allow for advertising messages to be rotated easily, and provide for the possibility of frequent updates or changes based on conditions (day of the week, time of day, weather, traffic patterns, etc.). However, electronic billboards are still designed in such a way as to utilize advertisements that pertain to large numbers of people.

### BRIEF DESCRIPTION OF DRAWINGS

FIG. 1 is a network diagram depicting a client-server system, within which one example embodiment may be deployed.

FIG. 2 is a block diagram illustrating multiple applications that, in one example embodiment, are provided as part of the networked system

FIG. 3 is a diagram illustrating a system, in accordance with an example embodiment, of intelligently targeting advertising in an electronic billboard.

FIG. 4 is a diagram illustrating a system, in accordance with another example embodiment, of intelligently targeting advertising in an electronic billboard.

FIG. 5 is a diagram illustrating a system, in accordance with an example embodiment, of multiple electronic billboards.

FIG. 6 is a diagram illustrating a system, in accordance with an example embodiment, including an electronic billboard and multiple groups of vehicles.

FIG. 7 is a diagram illustrating a system, in accordance with an example embodiment, including an electronic mall sign.

FIG. 8 is an interaction diagram illustrating a method, in accordance with an example embodiment, of controlling an electronic sign/billboard.

FIG. 9 is a flow diagram illustrating a method, in accordance with an example embodiment, of controlling an electric sign.

FIG. 10 is a block diagram of a machine in the form of a computer system within which a set of instructions for causing the machine to perform any one or more of the methodologies discussed herein may be executed.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

In an example embodiment, an electronic billboard or sign is designed so as to display targeted, intelligent advertisements. User profiles of users in the vicinity (or soon to be in the vicinity) of the electronic billboard or sign can be retrieved. The message or advertisement on this electronic billboard or sign can then be targeted based on an aggregation of these user profiles.

Targeted intelligent advertising essentially includes two parts. In the first, user profiles may be generated. In one example embodiment, the user profiles may be generated based on actual transactions or activities undertaken by users. In another example embodiment, the user profiles may be generated based on certain assumptions determined during the time that the corresponding users are within the vicinity of the electronic billboard or sign. Of course, embodiments are also possible that combine these techniques.

In the second part of targeted intelligent advertising, the user profiles, regardless of how they were generated, are used to determine an electronic advertisement or message.

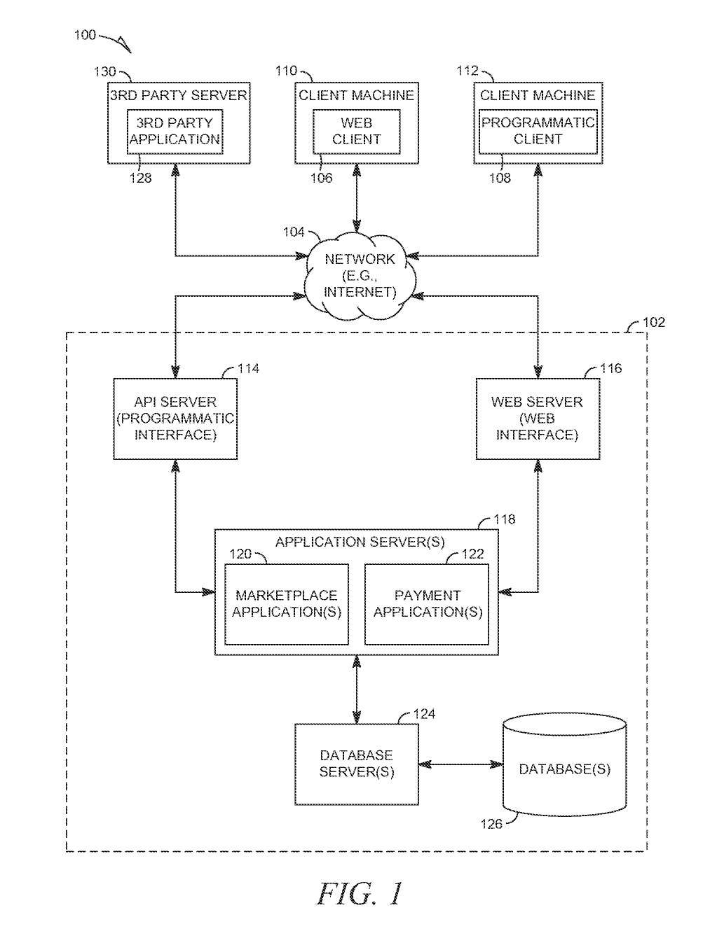

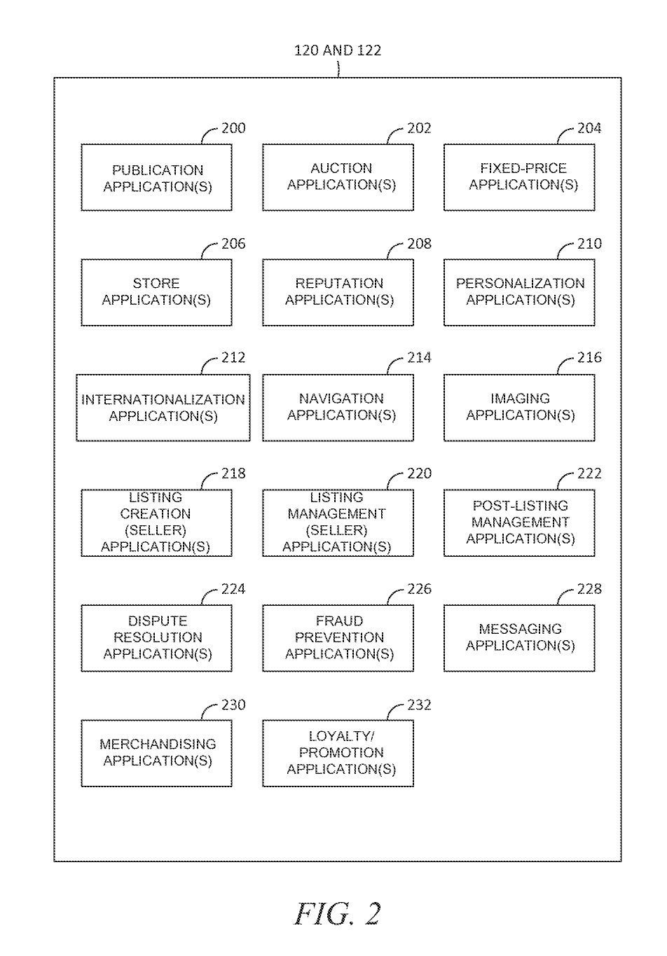

As to the first part, when user profiles are generated based on actual transactions or activities undertaken by users, a system may be used to monitor such transactions or activities. FIGS. 1 and 2 depicts one such system.

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or a Wide Area Network (WAN)) to one or more clients. FIG. 1 illustrates, for example, a web client 106 (e.g., a browser, such as the Internet Explorer browser developed by Microsoft Corporation of Redmond, Wash. State) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more database servers 124 that facilitate access to one or more databases 126.

The marketplace applications 120 may provide a number of marketplace functions and services to users who access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the embodiments are, of course not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, or payment functions that are supported by the relevant applications of the networked system 102.

FIG. 2 is a block diagram illustrating marketplace and payment applications 120 and 122 that, in one example embodiment, are provided as part of the networked system 102. The applications 120 and 122 may be hosted on dedicated or shared server machines (not shown) that are communicatively coupled to enable communications between server machines. The applications 120 and 122 themselves are communicatively coupled (e.g., via appropriate interfaces) to each other and to various data sources, so as to allow information to be passed between the applications 120 and 122 or so as to allow the applications 120 and 122 to share and access common data. The applications 120 and 122 may furthermore access one or more databases 126 via the database servers 124.

The networked system 102 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace and payment applications 120 and 122 are shown to include at least one publication application 200 and one or more auction applications 202, which support auction-format listing and price setting mechanisms (e.g., English, Dutch, Vickrey, Chinese, Double, Reverse auctions, etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives, and features that are specific and personalized to a relevant seller.

Reputation applications 208 allow users who transact, utilizing the networked system 102, to establish, build, and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user (for example, through feedback provided by other transaction partners) to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page at which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States, Each of these versions may operate as an independent marketplace or may be customized (or internationalized) presentations of a common underlying marketplace. The networked system 102 may accordingly include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application 214) may enable key word searches of listings published via the networked system 102. A browse application may allow users to browse various category, catalogue, or inventory data structures according to which listings may be classified within the networked system 102. Various other navigation applications 214 may be provided to supplement the search and browsing applications.

In order to make listings available via the networked system 102 as visually informing and attractive as possible, the applications 120 and 122 may include one or more imaging applications 216, which users may utilize to upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller conveniently to provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102 (such as, for example, messages advising users regarding the status of listings at the networked system 102 (e.g., providing “outbid” notices to bidders during an auction process or to provide promotional and merchandising information to users)). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotions applications 232. For example, a buyer may earn loyalty or promotion points for each transaction established and/or concluded with a particular seller, and be offered a reward for which accumulated loyally points can be redeemed.

As described briefly earlier, in an example embodiment, information about customers can be gathered and used to aid in provisioning offers for advertising and other campaigns. In an example embodiment, this information about customers may be gathered from the above-described systems. Clustering may take place to organize the information, which may be stored in customer and transaction databases. From this information, user profiles may be defined and stored. The user profiles may include user interest information for the users. User interest information describes one or more interests, such as hobbies, likes, dislikes, or other preferences that may be useful in determining which advertisements to serve. The profiles may also contain demographic information such as age, sex, level of education, and the like, that also may be useful in determining which advertisements to serve.

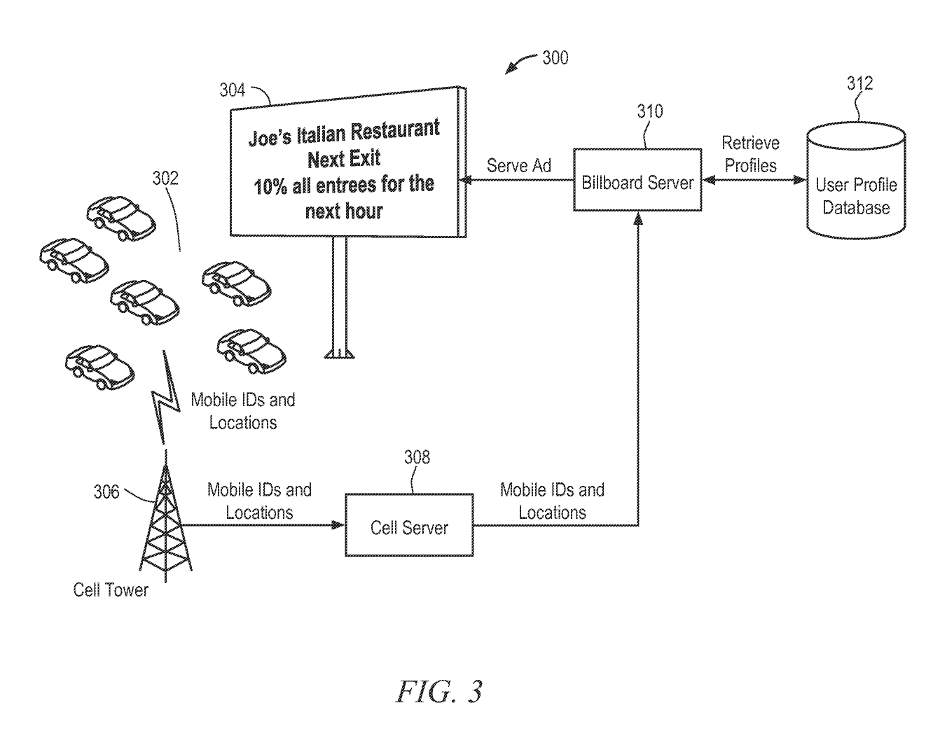

FIG. 3 is a diagram illustrating a system, in accordance with an example embodiment, of intelligently targeting advertising in an electronic billboard. In the system 300, users in vehicles 302 may be in the vicinity of an electronic billboard 304. The fact that the vehicles 302 are in the vicinity of the electronic billboard 304 may be determined in a number of different ways. In one example embodiment, mobile communication devices, such as cell phones, located in the vehicles 302 communicate with as cell tower 306. An application running on the cell phones may determine location based on, for example, global positioning system (GPS) information from GPS modules within the cell phones. This location information can be transmitted to the cell tower 306. This may be communicated via various wireless communication standards, such as Edge, 3G, 4G, LTE, WiFi, WiMax, etc. It should be noted that while the term “cell tower” and “cell server” are used, to the extent an embodiment is utilized using a non-cellular standard such as WiFi, the terms “cell tower” and “cell server” shall be interpreted broadly enough to cover the corresponding components in the non-cellular system (e.g., access point). A cell server 308 may receive this location information and forward it to a billboard server 310. The location information may include the location of the corresponding device (located in one of the vehicles 302) as well as an identification of a user, such as via an identification of the user's cell phone. The billboard server 310 may then retrieve user profile information from a user profile database 312, with the user profile information corresponding to the users identified as being in vehicles 302 within the vicinity of the electronic billboard 304.

While FIG. 3 depicts vehicles 302 within the vicinity of the electronic billboard 304, it will be recognized that vehicles that may be present outside of the vicinity of the electronic billboard 304 may still update the billboard server 310 with their location. In some embodiments, the billboard server 310 may monitor locations of vehicles not yet in the vicinity of the electronic billboard 304 but approaching the electronic billboard 304. This allows the billboard server 310 to have time to retrieve the appropriate profiles from the user profile database 312, aggregate the appropriate information, determine an advertisement or message to display, and transmit the advertisement or message to the electronic billboard 304 for display. In such embodiments, in addition to location information, speed and direction information about each vehicle may also be transmitted in order for the billboard server 310 to estimate when vehicles will be in the vicinity of the electronic billboard 304.

As described earlier, the advertisement or message on the electronic billboard 304 can be customized for the aggregate group of vehicles within the vicinity of the electronic billboard 304. Here, the aggregated profiles may indicate that this group of vehicles has a preference for Italian food. As such, an advertisement for an Italian restaurant is displayed on the electronic billboard 304. Customized discounts may also be provided. In this example, a discount of 10% off all entrees for just the next hour is provided. This discount may be adjusted based on other factors on top of the user profile information, such as the time of day, day of the week, weather, etc. The messages may even be customized based on these factors (e.g., “Tired of sitting in traffic? Stop at Joe's and enjoy lunch while the traffic clears,” or “It's very foggy up ahead. Stop at Joe's and enjoy dinner until the fog lifts”).

It should also be noted that traffic information may be gathered from a number of different possible sources, including a third party traffic server, as well as from the vehicles themselves, which may be receiving traffic information via cellular or FM broadcast in conjunction with embedded GPS devices.

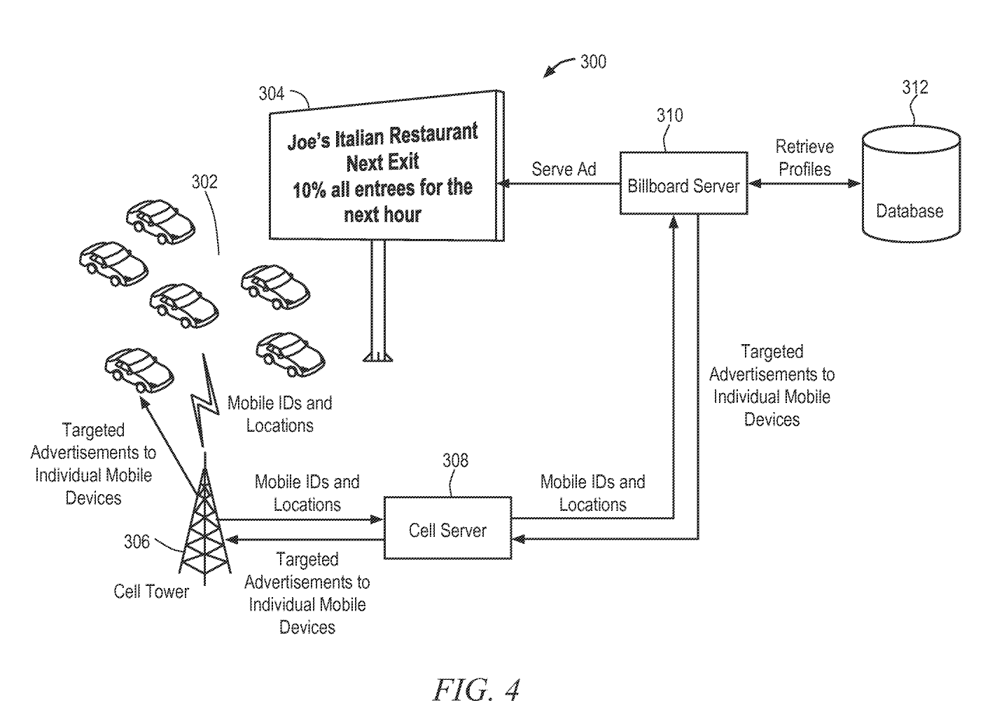

FIG. 4 is a diagram illustrating a system, in accordance with another example embodiment, of intelligently targeting advertising in an electronic billboard. Here, in addition to triggering an advertisement on the electronic billboard 304, the billboard server 310 also triggers targeted advertisements sent to individual mobile devices in vehicles 302. These targeted advertisements may include emails, text messages, and the like. In the case of text messages (e.g., SMS), the messages may even be timed to be received just as the corresponding vehicle arrives in the vicinity of the electronic billboard 304. These messages may include, for example, user-specific discounts based on the corresponding user profile. In this respect, the system may take into account the vehicle speed and traffic information in order to adjust the algorithm used to display the targeted advertisements in the vehicle.

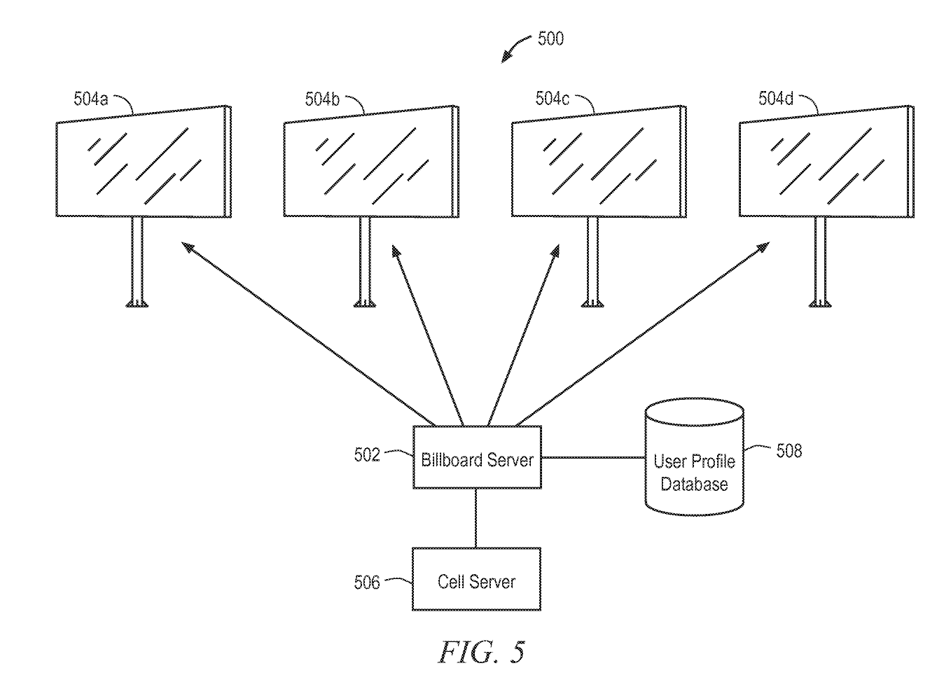

FIG. 5 is a diagram illustrating a system 500, in accordance with an example embodiment, of multiple electronic billboards. Here, a single billboard server 502 may control multiple electronic billboards 504a-504d. The multiple electronic billboards 504a-504d can display different advertisements based on the vehicles within the vicinity of each of respective electronic billboards 504a-504d. In some embodiments, these multiple electronic billboards 504a-504d can each act independently of one another. In other embodiments, the multiple electronic billboards 504a-504d may be coordinated for a coordinated advertising experience. For example, if the multiple electronic billboards 504a-504d are all in a line on the same road, an appropriate advertisement may be transitioned from billboard to billboard as a group of vehicles travels, ensuring more viewing time for the advertisement. As described earlier, the billboard server may interface with cell server 506 and user profile database 508 in determining which advertisements to serve to the billboards 504a-504d.

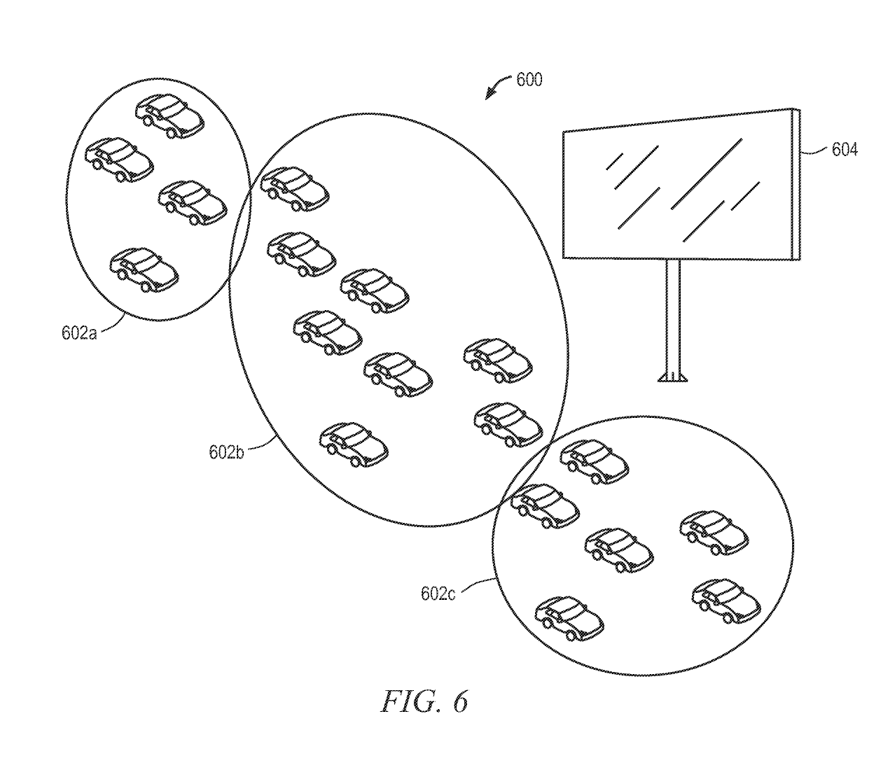

FIG. 6 is a diagram illustrating a system 600, in accordance with an example embodiment, including an electronic billboard and multiple groups of vehicles. Vehicles may be classified into one or more groups 602a, 602b, 602c. The profiles associated with mobile devices within the vehicles can then be aggregated according to the groups. As such, the groups 602a, 602b, 602.c can be organized in a manner to increase the likelihood that any particular group 602a, 602b, 602c will be “in the vicinity” of the electronic billboard 604 at any one time. Here, group 602a represents vehicles that are not yet within the vicinity of the electronic billboard 604. Group 602b represents vehicles that are currently within the vicinity of the electronic billboard 604. Group 602c represents vehicles that have passed the vicinity of the electronic billboard 604. The electronic billboard 604 may be currently displaying an advertisement selected based on the aggregation of the user profiles of the users in the vehicles of group 602b, with another advertisement being “readied” for display to the users of vehicles of group 602a when that group 602a arrives within the vicinity of the electronic billboard 604. The groups 602a, 602b, 602c may be dynamically updated as vehicles approach, and then pass, the electronic billboard 604.

It should be noted that that while in this figure, the groups 602a, 602b, 602c are depicted as being mutually exclusive, in some embodiments there may be overlaps between groups. For example, a vehicle may be both in group 602a and 602b, and its corresponding user profile used in the determination of which advertisements to show to both groups 602a and 602b.

The “vicinity” of an electronic billboard need not have any particular meaning and will vary based on the type of electronic billboard and intended viewer. For purposes of this document, the vicinity is simply an arbitrary value defining the outer limits of viewabitity of the electronic billboard and may be preselected by an advertiser or billboard owner. The distance defining the bounds of the vicinity need not be fixed and can dynamically vary based on a number of factors, such as average vehicle speed and weather. Generally, in some embodiments, the value representing the outer limits of the vicinity is simply selected to best represent the “edge” at which the average viewer could reasonably view the electronic billboard.

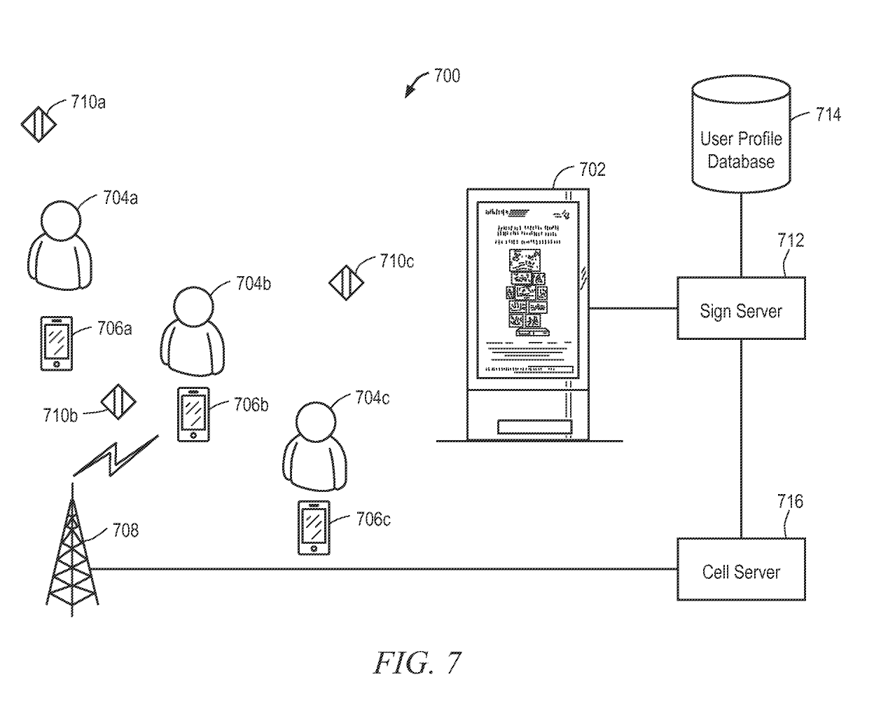

It should be noted that while the above figures depict an electronic billboard, any electronic sign could be used FIG. 7 is a diagram illustrating a system 700, in accordance with an example embodiment, including an electronic mall sign. Here, the electronic mall sign 702 may be located in a shopping mall, where individuals 704a-704c passing by can view it. The individuals 704a-704c may have mobile devices 706a-706c, which can transmit location and identification information to a cell tower 708. Due to the difficulty in obtaining accurate GPS signals inside shopping malls, in cases where such signals may be blocked, an alternative system for obtaining user location may be used. For example, sensors 710a-710c may be placed in the shopping mall, detecting passing mobile devices 706a-706c. These sensors 710a-710c may utilize various wireless communications standards, such as Bluetooth or near-field communication (NFC) standards.

A sign server 712 may operate to aggregate user profile information from a user profile database 714, based on the identification and location information received from a cell server 716.

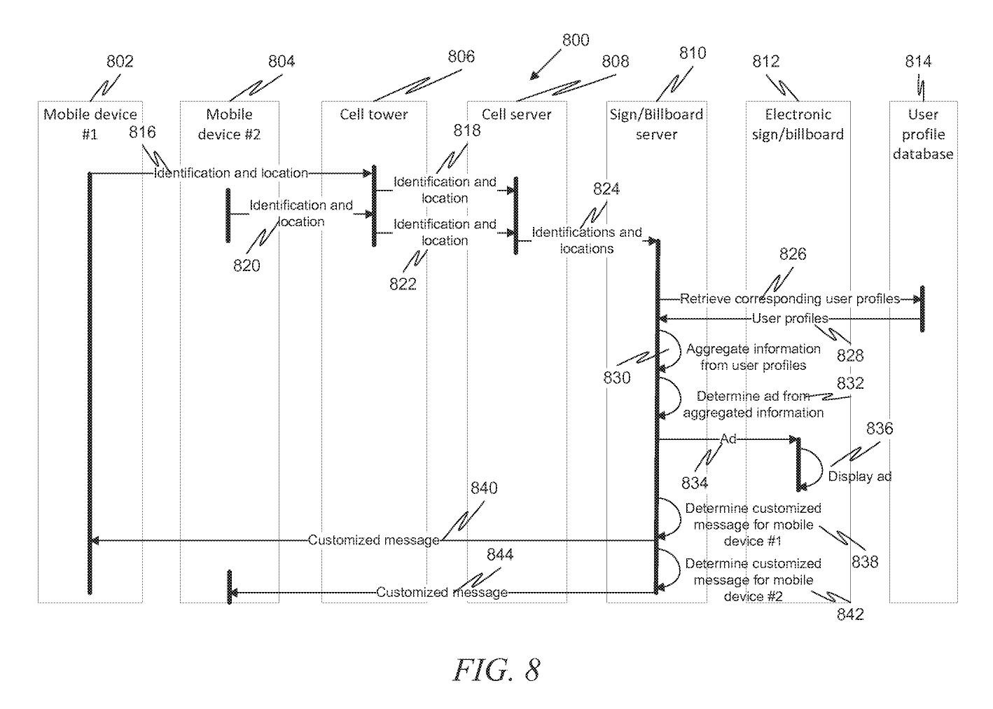

FIG. 8 is an interaction diagram illustrating a method 800, in accordance with an example embodiment, of controlling an electronic sign/billboard. The method 800 utilizes various components, including mobile device #1 802, mobile device #2 804, cell tower 806, cell server 808, sign/billboard server 810, electronic sign/billboard 812, and user profile database 814. While two mobile devices 802, 804 are depicted in this example embodiment, one of ordinary skill in the art will recognize that any number of mobile devices may be used. At 816, mobile device #1 802 sends an identification and a location to a cell tower 806. At 818, the cell tower 806 forwards the identification and location to the cell server 808. At 820, mobile device #2 804 sends identification and location information to the cell tower 806. At 822, the cell tower 806 forwards the identification and location to the cell server 806. At 824, the cell server 808 can send the identifications and locations from mobile device #1 802 and mobile device #2 804 to the sign/billboard server 810. It should be noted that while this diagram depicts these actions as being performed in a particular order, with the identifications and locations from all the mobile devices being gathered by the cell server 808 before forwarding to the sign/billboard server 810, in some embodiments the identifications and locations can be transmitted to the sign/billboard server 810 as they are received by the cell server 808.

At 826, the sign/billboard server uses the identifications from the mobile devices to retrieve corresponding user profiles from a user profile database 814. The user profiles are returned at 828. At 830, the sign/billboard server 810 aggregates information from the user profiles. In an example embodiment, this aggregation results in a list of shared user interests. At 832, the aggregated information is used to determine an advertisement to display. At 834, the advertisement is transmitted to the electronic sip/billboard 812, which displays it at 836.

At 838, a customized message for mobile device #1 802 can be determined, and at 840 it can be transmitted to mobile device #1 802. At 842, a customized message for mobile device #2 804 can be determined, and at 844 it can be transmitted to mobile device #2 804. This allows each mobile device 802, 804 to receive an individually customized message in addition to viewing the advertisement on the electronic sign/billboard 812 that was derived from shared interests.

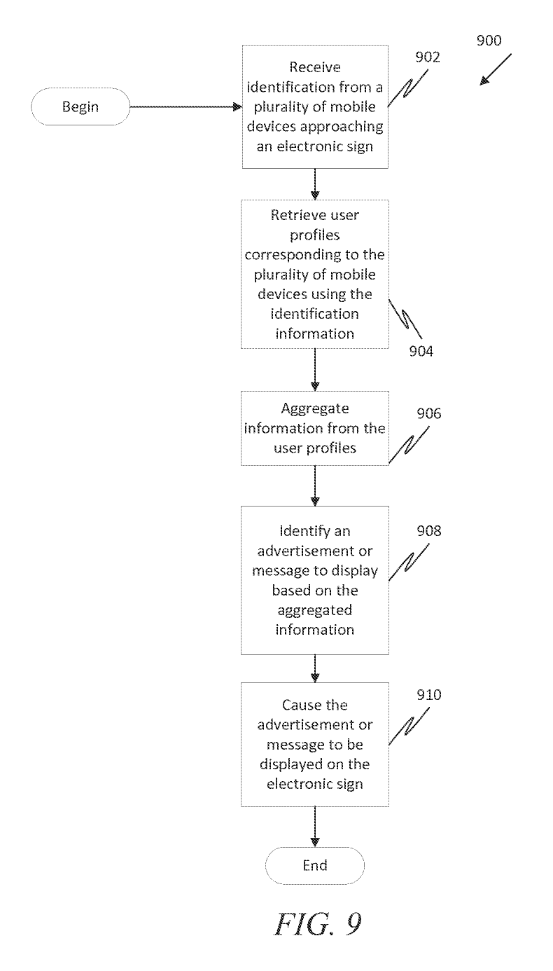

FIG. 9 is a flow diagram illustrating a method 900, in accordance with an example embodiment, of controlling an electric sign. At 902, identification information is received from a plurality of mobile devices approaching an electronic sign. At 904, user profiles corresponding to the plurality of mobile devices are retrieved using the identification information. At 906, information from the user profiles is aggregated. At 908, an advertisement or message to display to the plurality of mobile devices is identified based on the aggregated information. At 910, the advertisement or message is caused to be displayed on the electronic sign.

In another example embodiment, advertising time on the electronic sign can be dynamically auctioned to the approaching vehicles or people. For example, a driver may bid on advertising time on the electronic billboard that wishes one of the passengers a happy birthday. The driver may bid on this advertising time prior to approaching the electronic billboard, and the system may determine the appropriate time to display the message based on the vehicle's position and speed when. As such, not only is the advertising time dynamically auctioned to one or more vehicles (e.g., the price adjusting dynamically based on how many drivers wish to purchase time, how valuable the advertising time is (by virtue of how many other drivers are on the road), etc.) but the time when the message is displayed on the electronic billboard is also dynamically adjusted based on vehicle location and speed. This leads to a completely different model for displaying advertising/messages, where advertising time is adjusted dynamically based on the location of potential viewers.

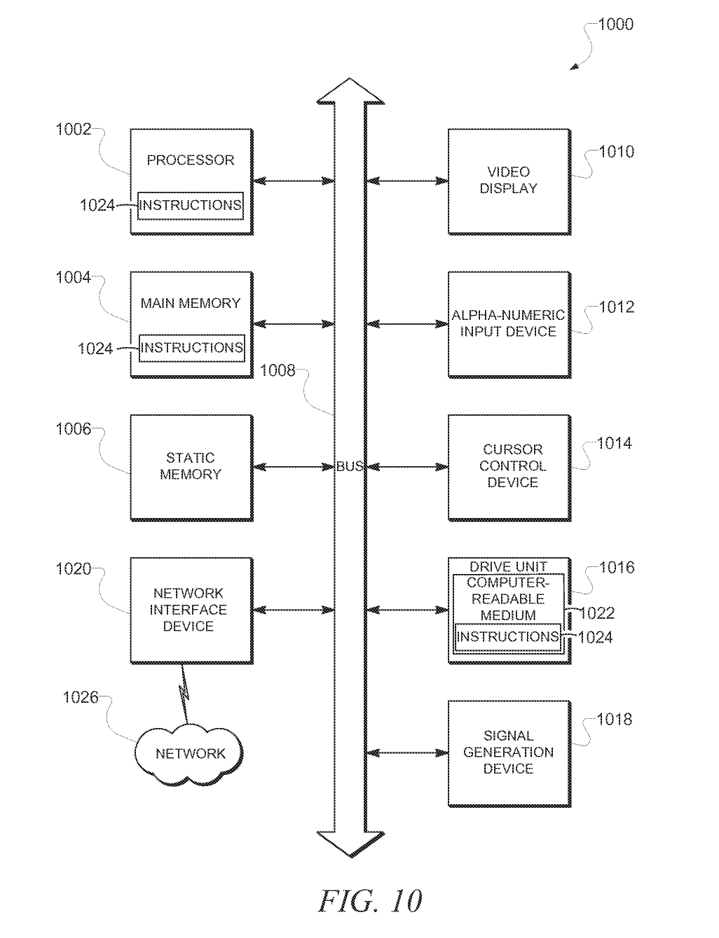

The billboard or sign server can take many forms. FIG. 10 is a block diagram of a machine in the form of a computer system within which a set of instructions may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. In one embodiment, the machine will be a server computer; however, in alternative embodiments, the machine may be a personal computer (PC), a tablet PC, a set-top box (STB), personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU) or both), a main memory 1004 and a static memory 1006, which communicate with each other via a bus 1008. The computer system 1000 may further include a display unit 1010, an alpha-numeric input device 1012 (e.g., a keyboard), and a user interface (UI) navigation (e.g., cursor control) device 1014 (e.g., a mouse). In one embodiment, the display unit 1010, input device 1012, and cursor control device 1014 are a touch screen display. The computer system 1000 may additionally include a storage device (e.g., drive unit) 1016, a signal generation device 1018 (e.g., a speaker), a network interface device 1020, and one or more sensors (not pictured) such as a GPS sensor, compass, accelerometer, or other sensor.

The drive unit 1016 includes a machine-readable medium 1022 on which is stored one or more sets of data structures and instructions 1024 (e.g., software) embodying or utilized by any one or more of the methodologies or functions described herein. The instructions 1024 may also reside, completely or at least partially, within the main memory 1004 and/or within the processor 1002 during execution thereof by the computer system 1000, with the main memory 1004 and the processor 1002 also constituting machine-readable media.

While the machine-readable medium 1022 is illustrated in an example embodiment to be a single medium, the term “machine-readable medium” may include a single medium or multiple media (e.g., a centralized or distributed database, and/or associated caches and servers) that store the one or more instructions 1024. The term “machine-readable medium” shall also be taken to include any tangible medium that is capable of storing, encoding or carrying instructions for execution by the machine and that cause the machine to perform any one or more of the methodologies of the embodiments of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The instructions 1024 may further be transmitted or received over a communications network 1026 using a transmission medium via the network interface device 1020 utilizing any one of a number of well-known transfer protocols (e.g., HTTP) Examples of communication networks include a local area network (LAN), a wide area network (WAN), the Internet, mobile telephone networks, Plain Old Telephone (POTS) networks, and wireless data networks (e.g., and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although an embodiment has been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

1. A server comprising:
a processor;
a memory; and
a sign server configured to:
receive identification information from a plurality of mobile devices approaching an electronic sign;
retrieve, using the identification information, user profiles corresponding to the plurality of mobile devices;
aggregate information from the user profiles;
identify an advertisement or message to display to the plurality of mobile devices based on the aggregated information; and
cause the advertisement or message to be displayed on the electronic sign.

2. The server of claim 1, wherein the electronic sign is an electronic billboard, and the mobile devices are associated with vehicles.

3. The server of claim 2, wherein one or more of the mobile devices are embedded within corresponding vehicles.

4. The server of claim 2, wherein the mobile devices transmit identification information and location information to a cell server, which forwards the identification information and location information to the sign server.

5. The server of claim 4, wherein the mobile devices transmit identification information and location information via a cellular network.

6. The server of claim 2, wherein the location information includes global positioning system (GPS) information.

7. The server of claim 2, wherein the sign server is further configured to create personalized messages for one or more of the mobile devices based on the user profiles.

8. The server of claim 1, further including an auction module configured to:
receive bids on advertisement time for the electronic billboard from one or more of the mobile devices;
award advertisement time for the electronic billboard to a high bidder based on the received bids; and
cause a advertisement corresponding to the high bidder to be displayed on the electronic billboard.

9. A method for controlling an electronic sign, comprising:
receiving identification information from a plurality of mobile devices approaching an electronic sign;
retrieving user profiles corresponding to the plurality of mobile devices using the identification information;
aggregating information from the user profiles;
identifying an advertisement or message to display to the plurality of mobile devices based on the aggregated information; and
causing the advertisement or message to be displayed on the electronic sign.

10. The method of claim 9, wherein the aggregating includes determining one or more shared user interests among the retrieved user profiles.

11. The method of claim 10, wherein the identifying includes identifying an advertisement or message that pertains to the one or more shared user interests.

12. The method of claim 9, wherein the plurality of mobile devices are located within vehicles.

13. The method of claim 12, wherein the mobile devices transmit identification information and location information to a cell server, which forwards the identification information and location information to a sign server.

14. The method of claim 13, further comprising receiving speed information from the mobile devices.

15. The method of claim 14, further comprising utilizing the location information and speed information from each vehicle to group the mobile devices based on estimated times when they will be in the vicinity of the electronic sign.

16. The method of claim 15, wherein the aggregating, identifying, and causing are performed independent tier each group of mobile devices.

17. The method of claim 9, further comprising creating personalized messages for one or more of the mobile devices based on the user profiles.

18. The method of claim 17, wherein the personalized messages are coordinated with the advertisement or message caused to be displayed on the electronic sign.

19. The method of claim 18, wherein the personalized messages are transmitted to individual mobile devices.

20. The method of claim 9, further comprising:
receiving bids on advertisement time for the electronic billboard from one or more of the mobile devices;
awarding advertisement time for the electronic billboard to a high bidder based on the received bids; and
causing a advertisement corresponding to the high bidder to be displayed on the electronic billboard.

21. A non-transitory computer-readable storage medium comprising instructions that, when executed by at least one processor of a machine, cause the machine to perform:
receiving identification information from a plurality of mobile devices approaching an electronic sign;
retrieving, using the identification information, user profiles corresponding to the plurality of mobile devices;
aggregating information from the user profiles;
identifying an advertisement or message to display to the plurality of mobile devices based on the aggregated information; and
causing the advertisement or message to be displayed on the electronic sign.
